(19) United States
(12) Patent Application Publication
(10) Pub. No.: US 2004/0027380 A1
(43) Pub. Date: Feb. 12, 2004

(54) Electronic appliance and program generation method thereof

(76) Inventor: Naomasa Takahashi, Chiba (JP)

Correspondence Address: FROMMER LAWRENCE & HAUG LLP, 745 FIFTH AVENUE, NEW YORK, NY, 10151, US

(21) Appl. No.: 10/634,093

(22) Filed: Aug. 4, 2003

(30) Foreign Application Priority Data
Aug. 7, 2002 (JP) P2002-230496

(51) Int. Cl. G09G 5/00

(52) U.S. Cl. 345/764

(57) ABSTRACT

An electronic apparatus capable of customizing a screen of free layout for image information from a plurality of media through simple operations, and a method for generating a program to be used for the electronic apparatus. Selected display information such as the location and the size of a display screen area for generating a program for displaying an image on a display unit is displayed on the display unit. Generated information for generating a program corresponding to the selected display information such as a plurality of kinds of elements of editing information of a DOM tree is stored. The stored elements are selected corresponding to the selected display information displayed on the display unit, and the generated information is generated. Then, the program for displaying the image is generated on the basis of the generated information.

### CROSS REFERENCE TO RELATED APPLICATIONS

The present document is based on Japanese Priority Application JP2002-230496, filed in the Japanese Patent Office on Aug. 7, 2002, the contents of which being incorporated herein by reference to the extent permitted by law.

### BACKGROUND OF THE INVENTION

1. Field of the Invention

The present invention relates to a program generation method for electronic apparatuses or appliances such as televisions, personal digital assistants (PDA)s, camcorders and the like.

2. Description of the Related Art

Conventional art related to display layout for image information from a plurality of media resources includes technology called Multimedia Presentation in which a plurality of media layout and simultaneous reproduction is carried out according to a scenario described in a XML (eXtensible Markup Language) format such as SMIL (Synchronized Multimedia Integration Language).

XML, which stands for extensible Markup Language, is considered an important markup language with high potentiality to become standard for exchange and distribution of texts, data, etc., over the Internet.

In addition, SMIL is a tool for unifying and realizing synchronization of multimedia data such as still image, moving image, audio data, etc., with Web pages (where Web stands for World Wide Web).

### SUMMARY OF THE INVENTION

However, in the technologies described above, a content creator in general presents a user with a layout of a plurality of media in a single combination to be browsed by the user, thus it is basically impossible for the user to freely select the layout.

In addition, since those technologies do not assume any electronic apparatus other than a personal computer (PC), the only available interfaces for content browsing are a mouse and a keyboard, which may constitute a barrier for an ordinary user.

Consequently, it is an actual situation that, when a user wants to customize a screen layout of image information and the like from a plurality of media, input of the size of a layout screen and a uniform resource locator (URL) indicating a location of content on the Web, etc. with electronic appliance-based resources such as TV sets is difficult in terms of usability.

The present invention has been conceived in view of the problems described above. It is an advantage of the invention to provide electronic appliance capable of customizing a screen of free layout of image information from a plurality of media by means of simple operations, and a program generation method to be used in the electronic appliance.

An electronic appliance according to a preferred embodiment of the present invention includes a display section for displaying image; a housing means for housing a plurality of types of constitutive elements utilized in generation of generated information for generating a program for display of image on the display section, and for housing selected display information for selection of a constitutive element from the plurality of types of constitutive elements on the display section; a selection means for selecting a constitutive element from the plurality of types of constitutive elements, according to the selected display information displayed on the display section; and a generation means for generating the generated information based on a result of selection by the selection means and generating the program based on the generated information.

In the present invention, selected display information such as the location and the size of a display screen area for generating a program for displaying an image on a display unit is displayed on the display unit, and generated information for generating a program corresponding to the selected display information such as a plurality of kinds of elements of the editing information of a DOM tree is stored. Then, the stored elements are selected according to the selected display information displayed on the display unit to generate the generated information. Furthermore, the program for displaying the image is generated on the basis of the generated information. As a result, a user may select and combine elements through simple operations without being aware of detailed elements, while creating a customized, free layout screen.

In addition, an example of plurality of constitutive elements or elements of the program generation information is parameter such as attributes included in the SMIL (Synchronized Multimedia Integration Language).

An electronic appliance according to another preferred embodiment of the present invention includes, in addition to the above mentioned elements, the selection means selecting and displaying on the display section a plurality of selected display information from the plurality of selected display information housed in the housing means, if there is a plurality of selected display information housed in the housing means. As a result, detailed and appropriate selected display information may be provided. For example, upon storing a plurality of screen layout samples, it becomes possible for the user to easily customize the screen layout, as the user may choose display the screen layout that most fits his/her preference.

An appliance according to the preferred embodiment of the present invention may still have the selection means that makes display on said display section, selected display information other than the selected and displayed selected display information. As a result, it becomes possible to display information consecutively, for example display the screen layout samples consecutively with a simple operation through a remote controller, for example, thus improving usability.

In addition, an electronic appliance according to another preferred embodiment of the present invention has the housing means housing a program generated by said generation means. As a result, it becomes possible to previously generate the program, thus permitting realizing fast screen layout when necessary and also, for example, store a plurality of programs and display them in sequence, so that a program may be selected that displays a most fitful or convenient image.

In addition, an electronic apparatus according to another preferred embodiment of the present invention includes a display section for displaying image; a housing means for housing a plurality of generation information for generating a program for display of image on the display section, and for housing selected display information for selection of a piece of generation information from the plurality of generation information on the display section; a selection means for selection of a piece of generation information from the plurality of generation information, according to the selected display information displayed on the display section; and a generation means for generating the program based on a result of the selection.

According to such preferred embodiment of the present invention, selected display information such as the location and the size of a display screen area and the like for generating a program for displaying an image on a display unit is displayed on the display unit, and generated information for generating a program corresponding to the selected display information such as the editing information itself of a DOM tree is stored. The stored generated information is then selected according to the selected display information displayed on the display unit to generate the program for displaying the image on the basis of the generated information. As a result, the user may him/herself create a free layout screen with simple operations.

A program generating method according to a preferred embodiment of the present invention includes a housing step of housing a plurality of types of constitutive elements utilized in generation of generated information for generating a program for display of image on a display section, and of housing selected display information for selection of a constitutive element from the plurality of types of constitutive elements on the display section; a selection step of selecting a constitutive element from the plurality of types of constitutive elements, according to the selected display information displayed on the display section; and a generation step of generating the generated information based on a result of selection by the selection step and generating the program based on the generated information.

According to such preferred embodiment of the present invention, selected display information such as the location and the size of a display screen area and the like, for generating a program for displaying an image on a display unit, is displayed on the display unit, and generated information for generating a program corresponding to the selected display information such as a plurality of kinds of elements of the editing information of a DOM tree is stored. Then, the stored elements are selected according to the selected display information displayed on the display unit to generate the generated information. Furthermore, the program for displaying the image is generated on the basis of the generated information. As a result, a user may select and combine elements with simple operations, without having to be aware of the detailed elements or components, so that the user may create a more customized and freely arranged layout screen.

A program generating method according to another preferred embodiment of the present invention includes may still have the selection step that makes display on said display section, selected display information other than the selected and displayed selected display information. As a result, it becomes possible to display information consecutively, for example display the screen layout samples consecutively with a simple operation through a remote controller, for example, thus improving usability

A program generating method according to still another preferred embodiment of the present invention includes a housing step of housing a plurality of generation information for generating a program for display of image on a display section, and of housing selected display information for selection of a piece of generation information from the plurality of generation information on the display section; a selection step of selection of a piece of generation information from the plurality of generation information, according to the selected display information displayed on the display section; and a generation step of generating the program based on a result of the selection.

According to such preferred embodiment of the present invention, selected display information such as the location and the size of a display screen area and the like for generating a program for displaying an image on a display unit is displayed on the display unit, and generated information for generating a program corresponding to the selected display information such as the editing information itself of a DOM tree is stored. The stored generated information is then selected according to the selected display information displayed on the display unit to generate the program for displaying the image on the basis of the generated information. As a result, the user may him/herself create a free layout screen with simple operations.

According to the preferred embodiments of the present invention, a screen of free layout for image information from a plurality of media may be customized with simple operations.

### BRIEF DESCRIPTION OF THE DRAWINGS

The above and other objects, features and advantages of the present invention will become more apparent to those skilled in the art from the following description of the presently preferred exemplary embodiments of the invention taken in conjunction with the accompanying drawings, in which:

FIG. 1 is a schematic diagram showing the system of a television set according to a first preferred embodiment of the present invention;

FIG. 2 is a block diagram showing the control unit of the television set shown of FIG. 1;

FIG. 3 is a diagram describing a display program of a display screen layout according to the first preferred embodiment of the present invention;

FIG. 4 is a diagram describing part of a DOM tree edited for the generation of the display program shown in FIG. 3;

FIG. 5 is a diagram of the other part of the DOM tree edited for the generation of the display program shown in FIG. 3;

FIG. 6 is a flow chart showing the operation of the television set according to the first preferred embodiment of the present invention;

FIG. 7 is a diagram showing the selection of a screen layout example according to the first preferred embodiment of the present invention;

FIG. 8 is a table showing the parameters of the attribute values of generated information elements;

FIG. 9 is a diagram showing the selection of a screen area and the like according to the first preferred embodiment of the present invention;

FIG. 10 is a diagram showing the selection of a genre of favorite information and the like according to the first preferred embodiment of the present invention;

FIG. 11 is a diagram showing the case of selecting weather information according to the first preferred embodiment of the present invention;

FIG. 12 is a diagram showing the case of displaying a plurality of Webs in order according to the first preferred embodiment of the present invention; and

FIG. 13 is a diagram showing the case of inputting a URL for the case shown in FIG. 12.

### DESCRIPTION OF THE PREFERRED EMBODIMENTS OF THE INVENTION

Examples of preferred embodiments of the present invention applied to a television set will be described in the following,.

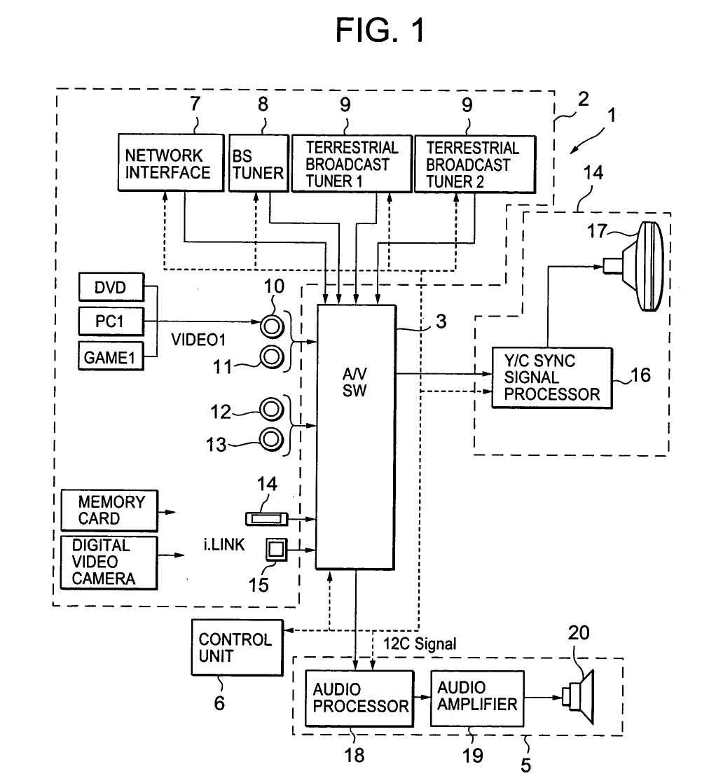

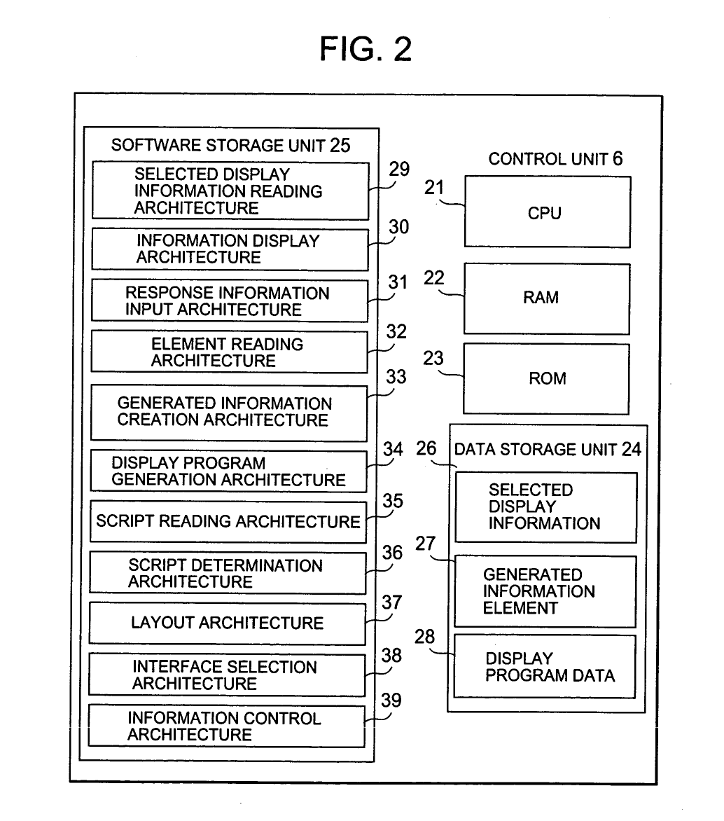

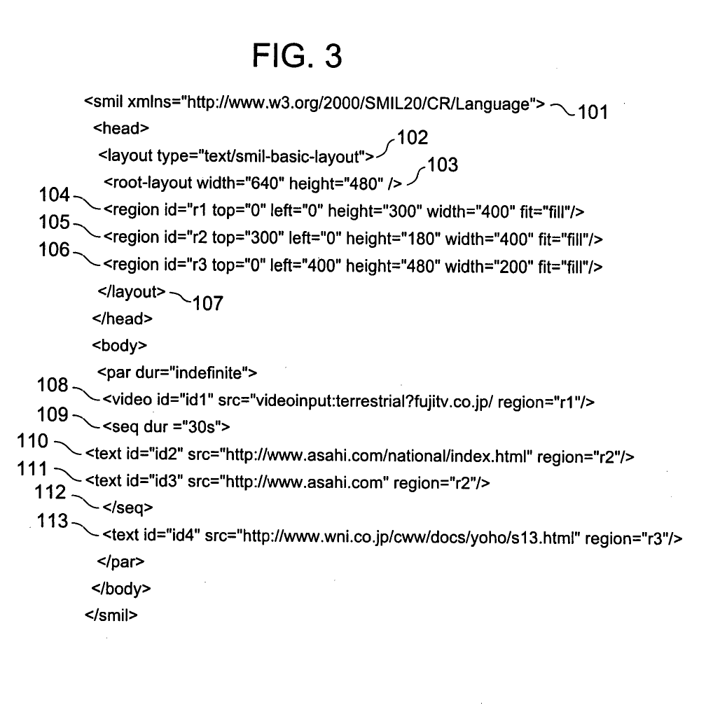

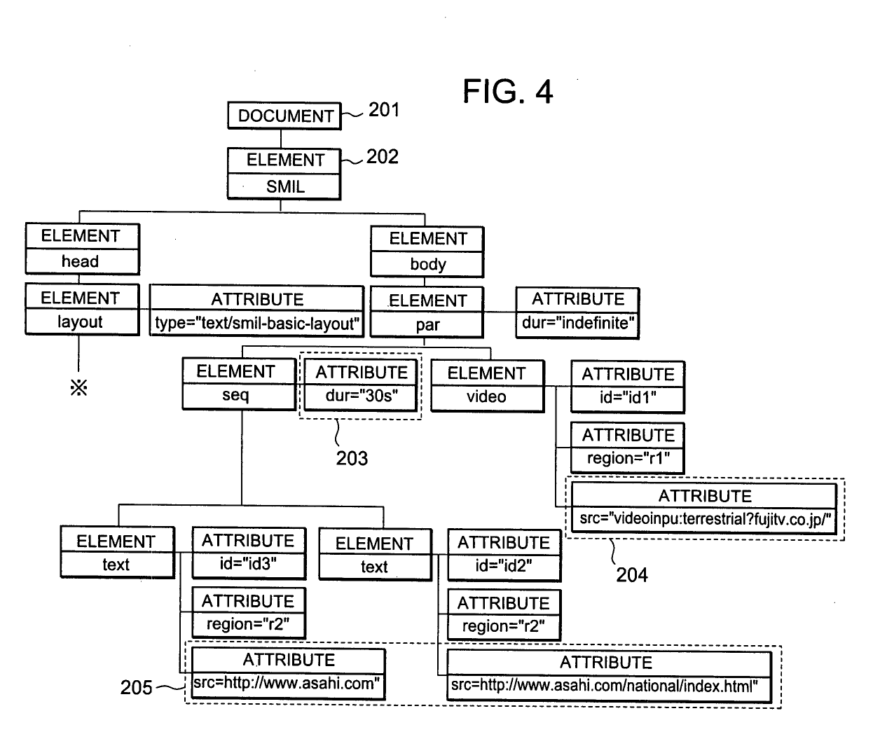

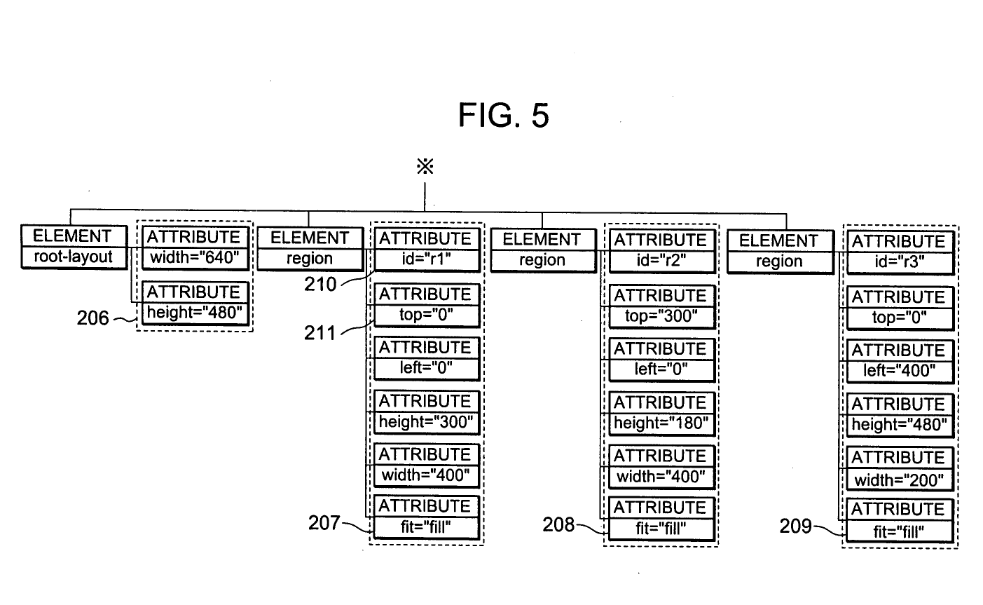

FIG. 1 is a schematic diagram showing the system of a television set according to a first preferred embodiment of the present invention; FIG. 2 is a block diagram showing the control unit of the television set shown in FIG. 1; FIG. 3 is a diagram of a display program of a display screen layout according to the first preferred embodiment of the present invention; and FIG. 4 and FIG. 5 are explanatory drawings of a DOM tree edited for the generation of the display program shown in FIG. 3.

As shown in FIG. 1, the television set 1 is composed of an interface unit 2 to which an external information source is connected, an audio visual switch (A/V SW) 3 for separating image information and acoustic information input from the interface unit 2, an video unit 4 for processing image information from the A/V SW 3, an audio unit 5 for processing audio information, and a control unit 6 for controlling the elements described above.

Hereupon, the interface unit 2 is provided with a network interface 7 to be connected to the Internet, a broadcasting satellite (BS) tuner 8 for performing the channel selection of BS broadcasts, terrestrial broadcast tuners 9 for performing the channel selection of terrestrial broadcasts, a video input terminal 10 and an audio input terminal 11 for performing input from video, audio and the like of an input terminal VIDEO 1, which is one of two input terminals, a video input terminal 12 and an audio input terminal 13 of an input terminal VIDEO 2, which is the other of the two, a memory card slot 14 for inputting information from a memory card, and a terminal i-LINK (a digital video (DV) terminal) 15 for inputting information from a digital video camera and the like.

For example, it is possible to input information and the like from a digital versatile disc (DVD) into the video input terminal 10 through a disc recorder.

In addition, it is also possible to input information from a personal computer (PC), a game machine, etc. into the video input terminal 10.

In addition, the video unit 4 is provided with a Y/C sync signal processor 16 for performing the control of a synchronous process of a luminance signal (Y) and a color difference signal (C) of image information from the A/V SW 3 and the like on the basis of control information from the control unit 6, and a display unit 17 displaying image information controlled by the Y/C sync signal processor 16.

Furthermore, the audio unit 5 is provided with audio processor 18 for controlling acoustic information from the A/V SW 3, for example, to reproduce audio with high fidelity approximate to live performance or to reproduce fine differences of audio quality of each instrument, an audio amplifier for amplifying an acoustic signal, and a speaker 20 for converting the amplified acoustic signal to audible sound.

In addition, as shown in FIG. 2, the control unit 6 is provided with a central processing unit (CPU) 21 performing an operation and control, a random access memory (RAM) 22 for recording image information, acoustic information, data, software and the like temporarily as the need arises, to perform the control of the television set 1 being electronic apparatus, a read only memory (ROM) 23, a data storage unit 24 and a software storage unit 25 storing various kinds of software.

As shown in FIG. 2, the data storage unit 24 stores selected display information 26, generated information element 27, display program data 28 such as the generated Synchronized Multimedia Integration Language (SMIL) data, and the like under the control of the control unit 6.

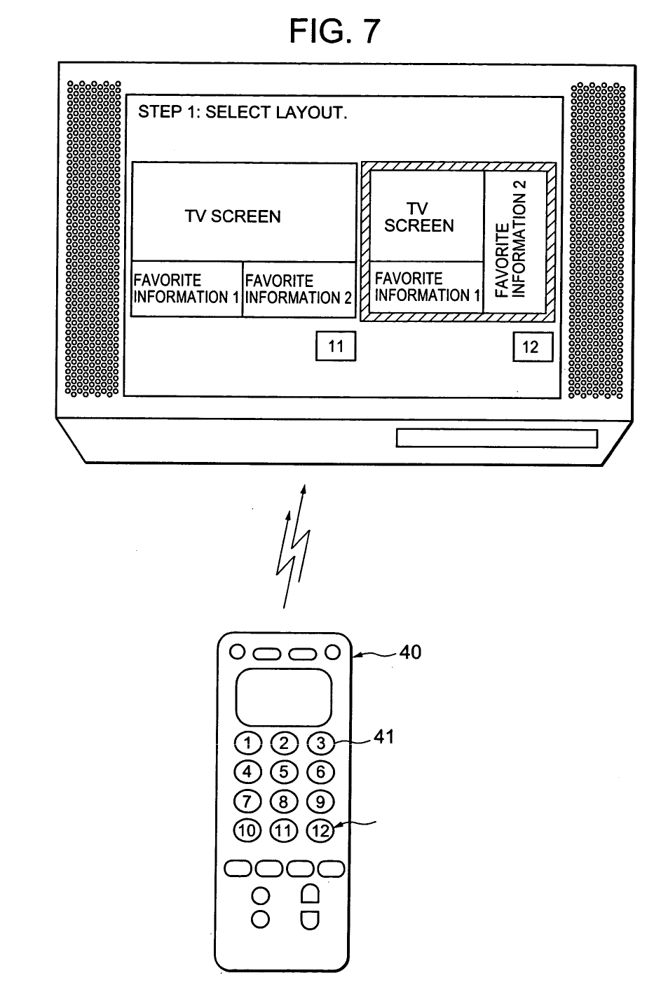

The selected display information 26 is information for displaying examples of how to configure a television screen such as the one shown in FIG. 7 on the display unit 17. By means of the selected display information 26, a user may select and input a favorite screen layout from several examples.

In addition, the generated information element 27 is a generated information element for generating, for example, SMIL data in order to correspond to the selected display information 26 by editing a Document Object Model (DOM) tree. The generated information element 27 may be freely defined within the scope of the rules of the Extensible Markup Language (XML) being the basis of the SMIL such as the element names “region” of elements 104-106 as shown in FIG. 3, the attribute names “id” of the elements 104-106, and the attribute values “r1” of the elements 104-106, and so on.

Hereupon, generated information generated for editing the DOM tree will be briefly described.

First, a DOM is supposed to define a program interface (an application program interface (API)) for a program in an actual apparatus to access the data of the SMIL to operate the data, and further is supposed to define an object model to be used by the interface.

A program equipped with the DOM is ordinarily integrated with an XML parser and an SMIL parser, which will be described later. After the SMIL parser parsed SMIL data, the SMIL parser enables the API of the DOM. That is, the SMIL parser outputs a set of objects of the DOM as a DOM tree. As a result, the program processing the SMIL data may access the DOM tree by the use of the API of the DOM.

Hereupon, for example, as shown in FIG. 4 and FIG. 5, a DOM tree includes a DOCUMENT object 201 indicating the whole SMIL data at the top and ELEMENT objects 202 indicating an “element” as the other DOM objects.

In addition, it is ascertained which tag an ELEMENT object indicates by referring to the tag name attribute of the ELEMENT. For example, tag names “SMIL”, “head”, “region” and the like are individually attached to each ELEMENT.

In addition, as shown in FIG. 4 and FIG. 5, the ELEMENT objects have attributes of “parentage and brother” relationships indicating the architecture of the DOM tree. If the attribute of an element is specified in SMIL data, the information of an attribute name and an attribute value, such as “id” in an attribute 210, “top” in an attribute 211 in case of the attribute name, and “r1”, “0” and the like in case of the attribute value, is collectively attached to ATTRIBUTE attributes of the ELEMENT objects.

Then, similarly to “objects” in an object-oriented solution, the DOM objects configuring the DOM tree have a property and a method. The property is data and related information which are held by the DOM object. The method indicates the behavior of the object.

As a result, it is possible to trace the DOM tree or to fetch the data held by the DOM object by referring to the attributes of the DOM object. Furthermore, the operations of the DOM tree are enabled by the use of the methods. That means that more customized SMIL data may be finally generated by editing the DOM tree by the use of the methods and newly create elements, attributes and the like.

In addition, FIG. 4. and FIG. 5 show a completed DOM tree. In FIG. 4 and FIG. 5, the specificly cited ELEMENT objects, the attribute names and the attribute values of the ATTRIBUTE attributes of the ELEMENT objects, and the like as well as their architecture are generated by means of the methods of the DOM objects in accordance with the procedure which will be described later.

For example, when a region element is newly generated, a method “createElement(“region”)” in a DOCUMENT object may be used. In addition, when an id attribute is generated, it is possible to use, for example, “createAttribute(“id”)” in a DOCUMENT object.

Furthermore, when a newly generated object is configured as SMIL data, an operation for associating the newly generated object with the other objects is needed. As the associating method, an “appendChild” method may be used as meaning attaching “newChild” to the end of a child node.

The generated information generated for editing the DOM tree is the information formed by collecting these methods. It is possible to freely define the elements of the methods such as the element names “region”, the attribute names “id” of the element names, the attribute values “r1” of the attribute names within the scope of the XML rules being as a basis of the SMIL. As a result, it becomes possible to generate the SMIL data customized for displaying a desired video screen by the use of the generated information.

Next, the software storage unit 25 is provided with a selected display information reading architecture 29, an information display architecture 30, a response information input architecture 31, an element reading architecture 32, a generated information creation architecture 33, a display program generation architecture 34, a script reading architecture 35, a script determination architecture 36, a layout architecture 37, an interface selection architecture 38, an information control architecture 39 and the like.

Hereupon, the selected display information reading architecture 29 read in the selected display information 26 to be stored in the data storage unit 24 under the control of the CPU 21. The read information is output to the information display architecture 30. In addition, when a plurality of pieces of the selected display information 26 exists, the selected display information reading architecture 29 may select the pieces of the selected display information 26 to be read in under the control of the CPU 21, and also select the pieces to be read in on the basis of the information from the response information input architecture 31, which will be described later in detail.

In addition, the information display architecture 30 makes the display unit 17 of the television set 1 display the selected display information 26 inputted from the selected display information reading architecture 29 under the control of the CPU 21.

In addition, when a user selects the selected display information displayed on the display unit 17, or performs similar operations, with a numeric key 41 of a remote control unit 40 and the like, the information from the numeric key 41 and the like is inputted into the response information input architecture 31 under the control of the CPU 21. Then, the response information input architecture 31 determines selection of a specific screen display information and outputs the determined specific screen display information to the element reading architecture 32.

In addition, the response information input architecture 31 may also make the selected display information reading architecture 29 read in other selected display information by the operation of the numeric key 41 of the remote control unit 40 to output the read selected display information to the information display architecture 30. As a result, it is possible to display the selected display information such as a screen layout example sequentially on the display unit 17 of the television set 1. As a result, screen layouts may be performed easily with simple apparatus such as the remote control unit 40.

Next, the element reading architecture 32 reads in the generated information element corresponding to the specific screen display information determined by the response information input architecture 31 from the data storage unit 24, and outputs the read generated information element together with the specific screen display information, or directly the specific screen display information, to the generated information creation architecture 33 under the control of the CPU 21.

For example, the element name “region”, the attribute name “id” of the element name, the attribute value “r1” and the like as shown in FIG. 3 are read in.

In addition, the generated information creation architecture 33 creates the generated information for editing the DOM tree from the input specific screen display information, the generated information element and the like under the control of the CPU 21, and outputs the created generated information to the display program generation architecture 34. The generated information creation architecture 33 creates the generated information by editing, for example, the method “createElement(“region”)” of a DOCUMENT object and by associating the method with other objects.

Next, the display program generation architecture 34 edits the DOM tree on the basis of the input generated information in accordance with the rules of the XML to generate new elements and attributes. As a result, a display program of SMIL data and the like are generated. As a result, the more customized display program may be generated, and a user him or herself may create a screen of free layout in a simple way.

In addition, the display program generation architecture 34 outputs a display program of the generated SMIL data and the like to the data storage unit 24 under the control of the CPU 21 as the need arises, and the data storage unit 24 stores the data.

Next, the script reading architecture 35 reads in the display program data 28 stored in the data storage unit 24, or a directly generated display program of the SMIL data and the like, under the control of the CPU 21. The read information is fed to the script determination architecture 36.

In this case, if there is a plurality of stored display programs, for example, display program selection information generated by the numeric key 41 of the remote control unit 40 from the CPU 21, the script reading architecture 35 determines or judges the existence of the specified display program stored in the data storage unit 24 and reads out the specified display program if there is no problem.

In addition, the script determination architecture 36 determines whether the read program is correct or legitimate XML data. When the program is legitimate XML data, the script determination architecture 36 performs the parsing of the read program, and further the script determination architecture 36 determines whether the read program is SMIL data. When the read program is SMIL data, the script determination architecture 36 performs the parsing of the read program to cut and divide the SMIL data into meaningful parts. As a result, the script determination architecture 36 generates a DOM tree, and enables the API of the DOM.

In addition, the script determination architecture 36 accesses the DOM tree by means of the API of the DOM. Then, the script determination architecture 36 separates the DOM tree into, for example, the elements for defining a plurality of display areas to perform the layout of each of the display areas, the elements for defining the external information sources the information from which is displayed in the defined display areas, and parts to which the other information is attached. As a result, the script determination architecture 36 determines the contents of the separated elements and the parts. As a result, since it may be defined to display the information from specific external information sources, it is possible to perform the layout of the information from the external information sources on the display screen freely by means of the rules of the universal resource identifier (URI).

More specifically, the script determination architecture 36 grasps the cut and divided parts as, for example, head elements and body elements. Then, the script determination architecture 36 determines whether display areas have been defined to layout elements and the layout of the layout elements have been performed with regard to the head elements, and also whether the external information sources the information from which is displayed in the defined display areas are defined with regard to the body elements.

When the layout architecture 37 receives, for example, the layout information of the layout elements based on the judgment of the parts defining the plural display areas of the read program to perform the layout of each of the display areas by the script determination architecture 36, the layout architecture 37 partitions the display screen to perform the layout of of each area of the partitioned display screen under the control of the CPU 21.

The interface selection architecture 38 may specify the external information source the information from which is displayed on the basis of “terrestrial” of an element 108 as shown in FIG. 3, transmitted from the script determination architecture 36.

The information control architecture 39 may deliver specific channel information such as a BS broadcast and the like to the BS tuner 8 as the control information of individual apparatus and the like by means of an information control parameter given by the script determination architecture 36.

Next, a language used for a display program will be briefly described.

For example, a display program using SMIL data defines information for selecting an interface for exchanging signals with an external information source by the use of a URI schema as a definition of the architecture of a database in accordance with the rules of the URI.

More specifically, the display program includes a part defining, for example, a plurality of display areas to perform the layout of each of the defined display areas, and a part or portion defining external information sources the information from which is severally displayed in the defined display areas and attaching other information to the defined display areas. As a result, since the displaying of the information from a specific external information source can be defined, it is possible to perform the layout of the information from the external information sources freely on the display screen by means of the rules of the URI.

For example, as shown in FIG. 3, in which SMIL data is described, a plurality of display areas specified by defining the display areas as having attribute values “r1” and so forth by means of the element names “region” and the attribute names “id” in the elements 104-106.

In addition, as the element 108, an external information source the information from which is displayed in each region defined by the above-mentioned region element can be specified by the URI. For example, by means of a schema “videoinput”, the external information source can be specified by the description following the schema “videoinput”.

In addition, the description of the URI depends on a schema. Usually, the description begins by describing a schema name to be used, and a colon character “:” follows. Then, a character string which the interpretation of which depends on the schema (scheme-specific-part) follows.

As a result, “videoinput” means to depend on “videoinput” as a schema for the interpretation of a character string to be described next. For example, if a schema is defined to input the information from the interface indicated by the character string described next, it is possible to specify the external information to be displayed in each display area by means of the description.

More specifically, if “terrestrial” is following a colon after “videoinput” in the element 108 shown in FIG. 3, the information from a terrestrial broadcast can be inputted.

In addition, it is necessary to designate specific channel information in some cases with regard to the apparatus for receiving the broadcasts having channels such as a BS broadcast, a terrestrial (ground wave) broadcast and the like. In such a case, it is possible to deal with the channel information in accordance with the rules of the URI.

More specifically, as the method for dealing with the channel information, there is a method to generally express the channel information as a query used in URL search home pages (HPs), bulletin board system (BBS) home pages and the like. For example, in case of BBS URLs, the channel information may be described as follows.

http:///bbs.arukikata.co.jp/report/europe/board/index.php ?qid=26

Hereupon, “qid=26” after “?” indicates a parameter to be delivered to a common gateway interface (CGI). More specifically, it becomes possible to instruct a server to take a description located at the 26th address in a message board in a BBS home page.

As a result, by introducing “?”, it becomes possible to exchange information with the apparatus or appliance. For example, as shown in the element 108 of FIG. 3, there is a method in which “fujitv.co.jp” is described after “?” to designate a URL of a channel and a broadcasting station as the display information for selecting a plurality of external information sources. As a result, the control unit 6 transmits an instruction instructing the acquisition of the channel information of Fuji Television Network, Inc. to the terrestrial broadcast tuners 9 selected by “videoinput:terrestrial”.

In addition, it also becomes possible to perform the control of apparatus such as the picture control, the contrast control and the like of the display screen by utilizing the animation function of the SMIL such as a dynamic change of the color of graphics, a movement of graphics by means of “?”.

However, it is possible to utilize all of the reserved matters within request for comments (RFC): 2396 for defining a URI specifying an address on the Internet to be used in SMIL data, by using “?” only, which just happens to be reserved on the URI.

In addition, display program data can be stored as the display program data 28 of the image information and the like which is subjected to several kinds of screen layouts. The display program data can be stored also in, for example a magnetic disk, a compact disk read only memory (CD-ROM) and the like. Furthermore, the display program data can be recorded in the other memories of the main body of the control unit 6 and external memories. As a result, the display program may have a variety of applications, and screen layouts become possible to realize in conformity with client apparatuses.

Next, the operation of the television set 1 configured as described above will be described focused on the generation of a display program.

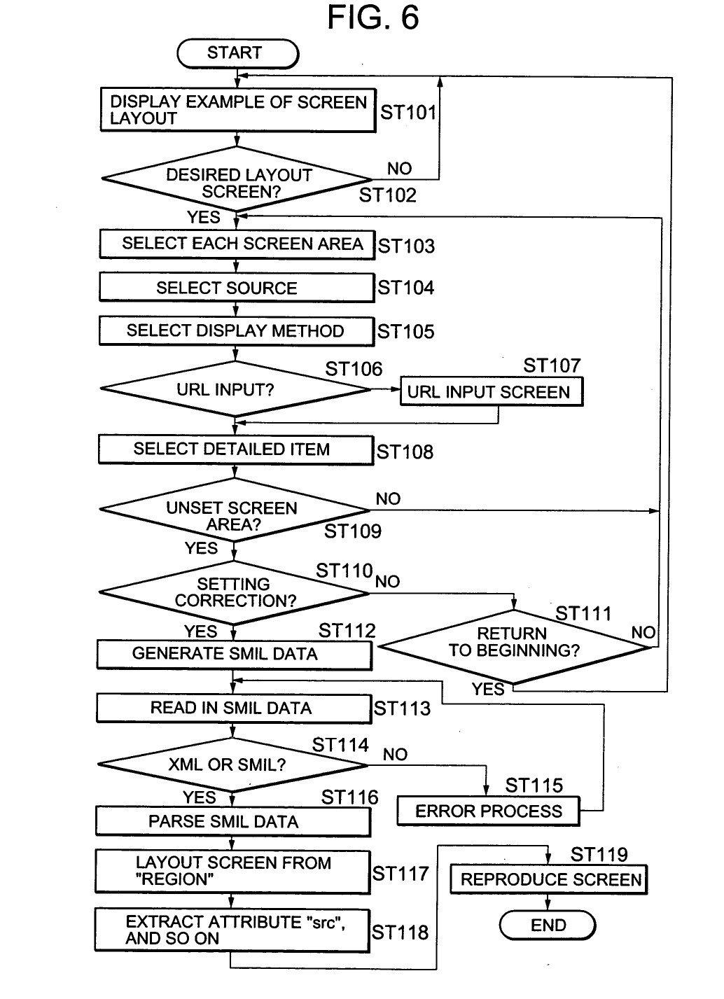

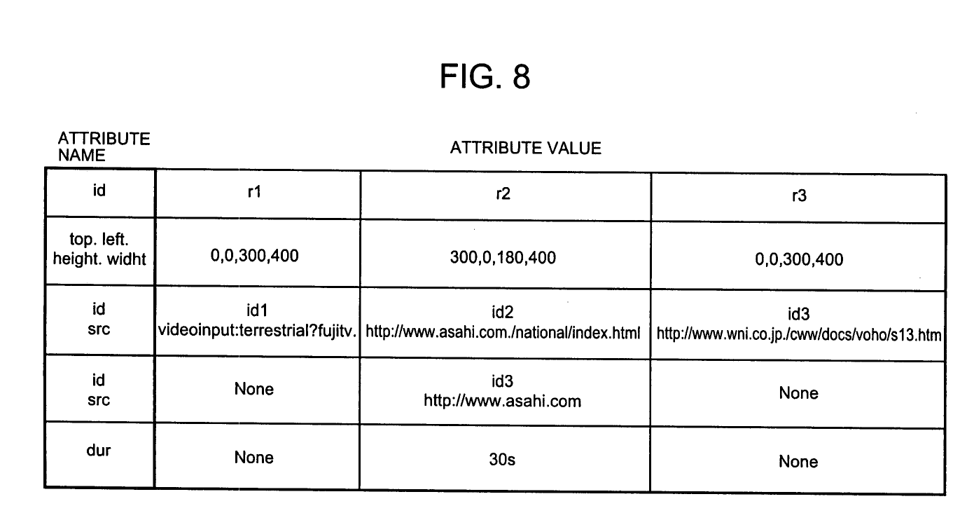

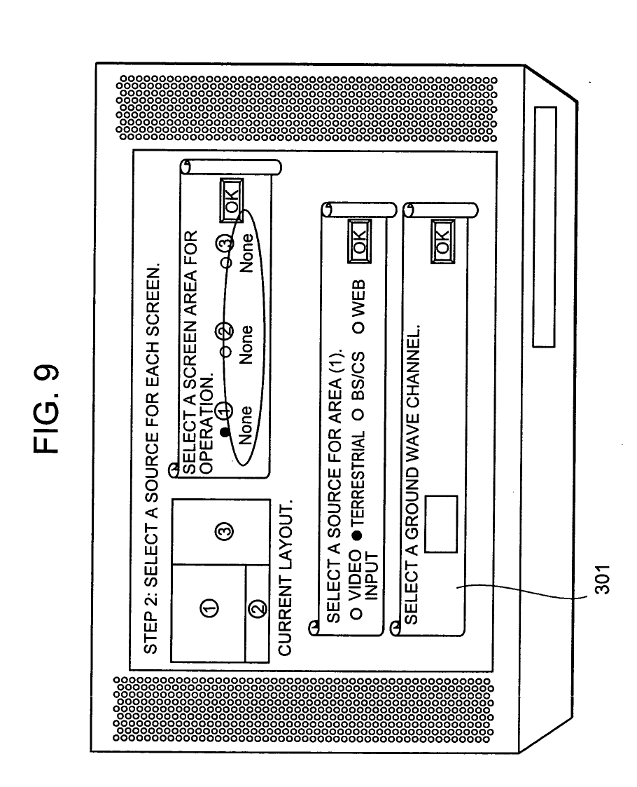

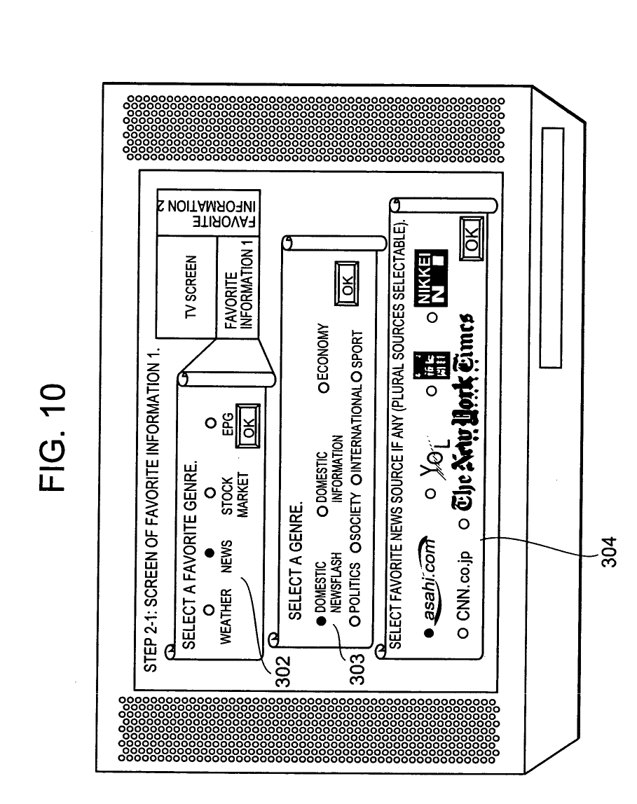

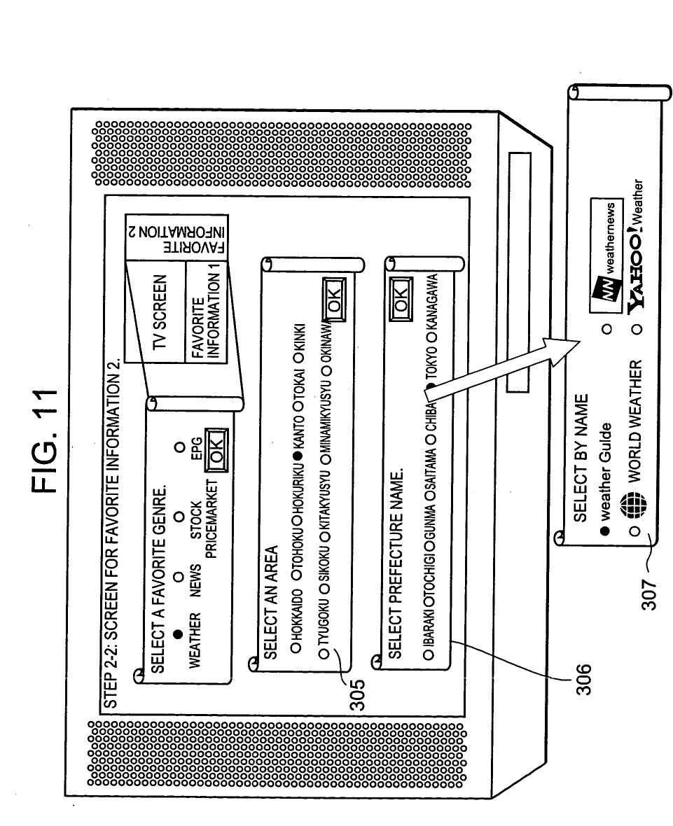

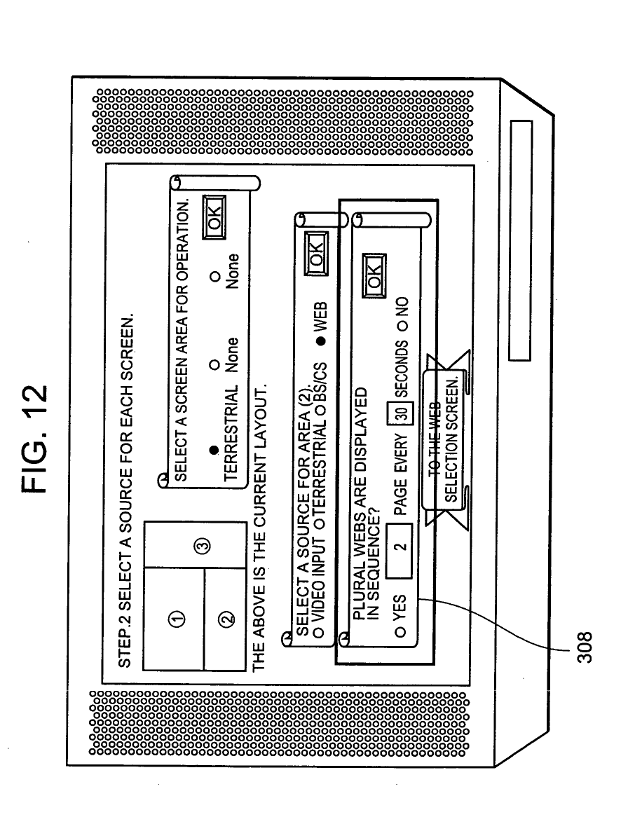

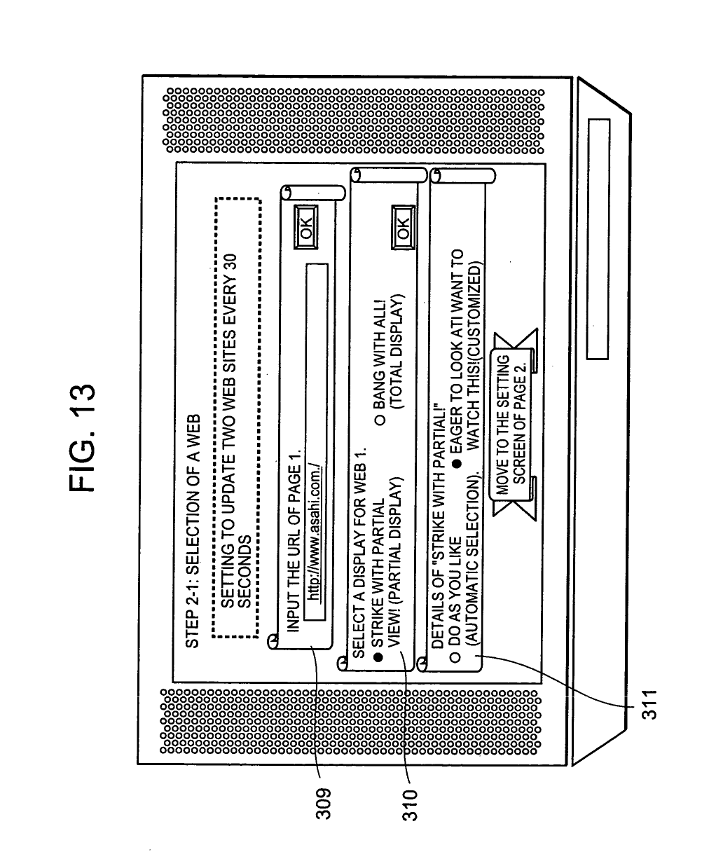

FIG. 6 is a basic flow chart; FIG. 7 is a diagram showing the selection of a screen layout example; FIG. 8 is a diagram showing the parameters of the attribute values as an example of generated information elements; FIG. 9 is a diagram showing the selection of a screen area and the like; FIG. 10 is a diagram showing the selection of a genre of favorite information and the like; FIG. 11 is a diagram showing the case of selecting weather information; FIG. 12 is a diagram showing the case of displaying a plurality of Webs in order; and FIG. 13 is a diagram showing the case of inputting a URL for the case shown in FIG. 12.

For example, the case where the information such as text information, Web information, broadcast broadcast information and the like are desired to be displayed on the screen of the display unit 17 of the television set 1 at the same time will be examined.

First, a screen customizing operation screen is displayed by an operation of, for example, the predetermined numeric key 41 of the remote control unit 40 of the television set 1.

Then, the information from the remote control unit 40 is inputted into the control unit 6 of the television set 1. The CPU 21 instructs the selected display information reading architecture 29 to read the selected display information 26 to be stored in the data storage unit 24. The selected display information read by the selected display information reading architecture 29 is displayed, for example, as a plurality of screen layout examples shown in FIG. 7 by the information display architecture 30 (Step ST101). It is needless to say that the screen layout examples are not only the two examples shown in FIG. 7, but other screen layout examples can be displayed until the desired layout screen is displayed by the operations of the remote control unit 40 and the like (Step ST102). In this case, the information generated by the operations of the remote control unit 40 and the like is inputted into the response information input architecture 31 of the control unit 6. Then, the response information input architecture 31 makes the selected display information reading architecture 29 read in the selected display information 26 being another screen layout example, and makes the information display architecture 30 successively display the screen layout examples.

When the desired layout screen is displayed, for example, to select the screen layout example on the right side in FIG. 7, a numeral 12 is inputted with the numeric key 41 of the remote control unit 40. The selection information of 12 and the selected display information of the selected screen layout example are inputted into the response information input architecture 31 under the control of the CPU 21, and a screen layout selected by the response information input architecture 31 is specified.

Next, the response information input architecture 31 outputs the specific screen display information being the specified screen layout to the element reading architecture 32 under the control of the CPU 21.

In addition, the element reading architecture 32 reads in the generated information element 27 corresponding to the specific screen display information from the data storage unit 24, and outputs the read generated information element 27 to the generated information creation architecture 33 together with the specific screen display information.

For example, in case of the screen layout example 12 of FIG. 7, the corresponding generated information elements are “root-layout” of the element 103, “region” of the elements 104-106, and the like as element names, “width”, “id”, “top” and the like as attribute names, and the parameters of “640”, “r1”, “0” and the like as attribute values. FIG. 8 shows examples of the parameters as attribute values.

The generated information creation architecture 33 creates program generated information for editing a DOM tree from the input specific screen display information, the generated information elements and the like under the control of the CPU 21, and the generated information creation architecture 33 temporarily stores the created program generated information into the RAM 22 or the data storage unit 24. The generated information creation architecture 33 edits, for example, the method “createElement(“region”)” and the like in the DOCUMENT objects, and relates the method with the other objects to create program generated information.

By the operation up to this stage, the generated information for editing the DOM tree, which corresponds to the screen layout example 12 shown in FIG. 7, as shown in FIG. 5 has been created. More specifically, as to the DOM tree to be edited, the sizes in length and breadth of the whole layout screen are specified by the attribute 206 being the attribute of the “root-layout” element, and the location and the size of the region “r1” is specified by the attribute 207 being the attribute of the “region” element. The other regions “r2” and “r3” are also specified by the attributes 208 and 209 similarly.

Next, the generated information creation architecture 33 instructs the selected display information reading architecture 29 to read in new selected display information 26 to be stored in the data storage unit 24 for guiding the operation of the next step under the control of the CPU 21. The selected display information read by the selected display information reading architecture 29 is displayed as, for example, a screen area selection and source selection screen as shown in FIG. 9 by the information display architecture 30, in Step ST103 and Step ST104.

Hereupon, as shown in FIG. 9, when a screen area exhibiting each area of the screen layout example 12 specified at Step ST102 is selected by an operation of the numeric key 41 of the remote control unit 40, for example, for selecting a screen area \mathring{1} in the figure, the numeric key 1 in the numeric key 41 is pushed and then a numeric key in the numeric key 41 corresponding to OK is further pushed for confirmation in accordance with guidance on the screen, the information is inputted into the response information input architecture 31 under the control of the CPU 21, and the attribute region “r1” corresponding to the selected screen area \mathring{1} is read in from the generated information element 27 of the data storage unit 24 by the element reading architecture 32 to be temporarily recorded into the RAM 22, for example.

In addition, as to the source of the information to be displayed in the selected screen area, specific source examples are displayed on the screen, for example, as shown in FIG. 9, and thereby the user can specify a desired information source among the source examples by operating the remote control unit 40 in a simple way. More specifically, the selected display information displaying “video input”, “terrestrial broadcast”, “BS/CS” and “WEB” is displayed by the information display architecture 30, and the information selecting any one of the displayed sources is inputted into the response information input architecture 31 by the use of the remote control unit 40 and the like. Incidentally, in FIG. 9, the operation screen at Step ST103 and the operation screen at Step ST104 are displayed on the same display screen. However, it is also possible to display the specific examples of the display information sources of the television screen, “video input”, “terrestrial broadcast”, “BS/CS” and “WEB”, under the control of the CPU 21 after the information indicating the selection of the area \mathring{1} of the television screen on the operation screen at Step ST103 has been inputted into the response information input architecture 31.

Next, if the user selected a selection choice “terrestrial broadcast” on the television screen and further pushed the numeric key 41 corresponding to OK for confirmation by operating the remote control unit 40 and the like, the information is outputted to the response information input architecture 31. Then, the response information input architecture 31 makes the information display architecture 30 display a channel input operation screen 301 as shown in FIG. 9.

Hereupon, if the user inputted a numeral corresponding to a channel number of Fuji Television Network, Inc. with the numeric key 41 of the remote control unit 40 and the user confirmed the input by pressing the button of OK, then the response information input architecture 31 collects the selected display information displayed up to this stage and the information inputted by means of the remote control unit 40 and the like. More specifically, the response information input architecture 31 generates the specific screen display information commanding display of the information of channel of Fuji Television Network, Inc., which is a terrestrial broadcast, in the screen area \mathring{1} under the control of the CPU 21.

Next, the response information input architecture 31 outputs the generated specific screen display information to the element reading architecture 32 under the control of the CPU 21.

Then, the element reading architecture 32 reads in the generated information element 27 corresponding to the specific screen display information from the data storage unit 24, and outputs the read generated information element 27 to the generated information creation architecture 33 together with the specific screen display information.

For example, in case of the specific screen display information indicating the displaying of the information of the channel of Fuji Television Network, Inc., which is a terrestrial broadcast wave, in the screen area \mathring{1} of FIG. 9, the corresponding generated information element had parameters such as “video” of the element 108 and the like as the element name thereof, “id”, “region”, “src” and the like as the attribute names thereof, and “id1”, “r1”, “videoinput:terrestrial?fujitv.co.jp/” and the like as the attribute values of the attribute names.

The generated information creation architecture 33 generates generated information for editing the DOM tree on the basis of the inputted specific screen display information, the generated information elements and the like under the control of the CPU 21, and temporarily stores the generated information in the RAM 22 or the data storage unit 24. For example, the method “createElement(“region”)” of a DOCUMENT object and the like are edited, associated with the other objects and the program generation information.

By the operation up to this stage, the generated information for editing the DOM tree, which is shown in FIG. 4 and corresponds to the specific screen display information for displaying the information of a channel of Fuji Television Network, Inc. being a terrestrial broadcast wave in the screen area \mathring{1} of FIG. 9 has been created. More specifically, as to the DOM tree to be edited, an instruction for acquiring the information of a channel of Fuji Television Network, Inc. is specified by means of the attribute 204 being the attribute of the “video” element.

Next, the generated information creation architecture 33 instruct the selected display information reading architecture 29 to read in new selected display information 26 to be store in the data storage unit 24 for guiding the next step operation under the control of the CPU 21. The selected display information read in by the selected display information reading architecture 29 is displayed, for example, as a screen area selection and source selection screen as shown in FIG. 10 by the information display architecture 30, in Step ST103 and Step ST104.

Since the screen area 02 may be selected by an operation similar to the operation of the selection of the screen area \mathring{1}, the description of the operation of the selection of the screen area \mathring{2} will be omitted. In addition, since the screen area is favorite information as shown in FIG. 10, it is also possible to make the selected display information reading architecture 29 read in selected display information of genres such as weather, news, a stock market, Electric Program Guide (EPG) and the like as the illustration of favorite genres to make the information display architecture 30 display the read selected display information under the control of the CPU 21.

Next, if the user selected the news 302 as a selection choice on the television screen and further pushed the numeric key 41 corresponding to the confirmation OK with operations of the remote control unit 40 and the like, then the information is outputted to the response information input architecture 31. The response information input architecture 31 makes the information display architecture 30 display a selection screen 303 of further specific genres such as a domestic newsflash, international information, economy, politics, international, sports and the like.

Hereupon, if the user inputted a numeral corresponding to the domestic newsflash with the numeric key 41 of the remote control unit 40 and the like and gave his or her OK to the input, then the response information input architecture 31 makes the information display architecture 30 display news sources 304 of specific domestic newsflashes such as legible source information such as pictorial symbols of “asahi.com” and the like for the user to select a news source.

In addition, the response information input architecture 31 collects the selected display information, the information inputted with the remote control unit 40, and the like up to this stage, and generates the specific screen display information indicating the display of the specific screen display information such as the display of “asahi.com” in the screen area \mathring{2} under the control of the CPU 21.

In addition, similarly in the case of the screen area \mathring{1}, the response information input architecture 31 outputs the specific screen display information, for example, to display “asahi.com” in the screen area \mathring{2} to the element reading architecture 32. The element reading architecture 32 reads in the generated information element 27 corresponding to the specific screen display information from the data storage unit 24 to output the read generated information element 27 to the generated information creation architecture 33 and the generated information creation architecture 33 creates generated information.

Next, the generated information creation architecture 33 instructs the selected display information reading architecture 29 to read new selected display information 26 to be stored in the data storage unit 24 for performing the operation guidance of the residual screen area \mathring{1} under the control of the CPU 21. The selected display information read by the selected display information reading architecture 29 is displayed as a source selection screen as shown in FIG. 11 by the information display architecture 30, in Step ST104.

In addition, since the screen area is for favorite information as shown in FIG. 11, it is also possible that the CPU 21 makes the selected display information reading architecture 29 read in the selected display information of the genres such as weather, news, a stock market, EPG and the like as the illustration of favorite genres to make the information display architecture 30 display the read selected display information under the control of the CPU 21 similarly in the screen area \mathring{1}.

Next, if the user selected the weather of a selection choice on the television screen with an operation of the remote control unit 40 and the like and further the user pushed a numeral key in the numeric key 41 corresponding to a confirmation OK, then the information is outputted to the response information input architecture 31. The response information input architecture 31 can be adapted to make the information display architecture 30 display further detailed information such as selected display information 305 illustrating specific regions in which weather is to be displayed, such as Hokkaido, Tohoku, Hokuriku, Kanto regions, as shown in FIG. 11.

In addition, it is also possible that, after the user selected rough region information, for example, Kanto, the selected display information 306 of an operation screen limiting regions more finely such as Ibaraki, Tochigi, Gunma, Saitama, Tokyo and the like is displayed on the information display architecture 30.

In addition, it is also possible to display a weather source 307 illustrating a weather guide, world weather and the like for the selection of the user.

As described above, it is possible to specify the information desired for view to some degree and to categorize the information. A user may specify a desired source in hierarchical categories such as a news system, a weather system, an information system and the like by means of the remote control unit 40 and the like. As a result, the user can freely perform the layout of a plurality of media which are desired for watch for watch at the same time in a simple manner without being obliged to perform complicated operations such as the input of URL's.

In addition, it is also possible to display a picture of a title of a Web and the like as shown in FIG. 10 and FIG. 11 for improving usability as much as possible in case of displaying source examples on a screen.

Next, the response information input architecture 31 collects the selected display information displayed up to this stage and the information inputted by means of the remote control unit 40 and the like. Then, the response information input architecture 31 generates the specific screen display information, for example, the specific screen display information designating display of “wni.co.jp/cww/docs/yoho/s13.html” in the screen area \mathring{3} under the control of the CPU 21.

Furthermore, similarly to the case of the screen area \mathring{1}, the response information input architecture 31 outputs the specific screen display information designating display “wni.co.jp/cww/docs/yoho/s13.html” in the screen area \mathring{3} to the element reading architecture 32. The element reading architecture 32 reads in the generated information element 27 corresponding to the specific screen display information from the data storage unit 24, and outputs the generated information element 27 to the generated information creation architecture 33. Thus, the generated information creation architecture 33 creates the generated information.

By the operation up to this stage, the generated information for all of the screen areas of the screen layout example 12 shown in FIG. 7 has been generated. It is further possible to display image information and the like on the display unit 17 of the television set 1 in various display methods, in Step ST105. For example, it is also possible to display a plurality of information in the same screen area in sequence in some description languages having such a function such as the SMIL.

More specifically, there is a method for inquiring of a user whether a plurality of Webs is displayed in sequence, and for requesting the user's inputs of specific numeric values with the remote control unit 40 and the like into the blanks of a page and a time interval of displaying the Webs in the case of performing the sequential display as shown in screen 308 in FIG. 12 in the source selection of the screen area \mathring{1}.

In addition, although a system is assumed for the source selections which does not presuppose input of URL's, it is also possible to provide a URL inputting screen as shown in FIG. 13, as the need arises.

For example, under the control of the CPU 21, the selected display information reading architecture 29 reads in selected display information concerning whether a user wants to input a URL in a source selection method or not from the data storage unit 24, and the information display architecture makes the display unit 17 display the selected display information. Then, the user inputs the information indicating that the user wants the input of the URL with the remote control unit 40 and the like. In such case, the response information input architecture 31 judges the input information under the control of the CPU 21, in Step ST106. When the response information input architecture 31 judges that the user wants to input the URL, the response information input architecture 31 instructs the selected display information reading architecture 29 to read in the selected display lo information for the URL inputting screen and to output the read selected display information to the information display architecture 30.

Then, the information display architecture 30 that has 15 received the selected display information displays a URL inputting screen 309 on the display unit 17, in Step ST107. As a result, it is possible to perform customization.

In addition, it is possible to select more detailed items for 20 customization in case of watching a plurality of media at the same time, in Step ST108. For example, as shown in a screen 310 in FIG. 13, it is possible to perform the display of information by limiting the information to a part thereof. Furthermore, it is also possible to define various display methods in detail as a screen 311 in which the user may specify the partial selection to be automatic selection or customized by the user's intention, and the like.

Next, the response information input architecture 31 collects the selected display information displayed up to this stage and the information inputted by means of the remote control unit 40 and the like. Then, the response information input architecture 31 generates specific screen display information, for example, the specific screen display information commanding display of “asahi.com/national/index.html” and “asahi.com” in the screen area \mathring{2} alternately every 30 seconds under the control of the CPU 21.

Furthermore, similarly to the case of the screen area \mathring{1}, the response information input architecture 31 outputs the generated specific screen display information to the element reading architecture 32. The element reading architecture 32 reads in the generated information element 27 corresponding to the specific screen display information from the data storage unit 24, and outputs the generated information element 27 to the generated information creation architecture 33.

For example, in case of the specific screen display information indicating the displaying of the information of “asahi.com/national/index.html” and “asahi.com” in the screen area \mathring{1} alternately every 30 seconds, the corresponding generated information elements have parameters such as “seq” of the element 109, “text” of the elements 110-111 and the like as their element names, “dur”, “id”, “region” and the like as their attribute names, and “30s”, “fd2”, “r2” and the Like as the attribute values of the attribute names.

The generated information creation architecture 33 generates generated information for editing the DOM tree on the basis of the inputted specific screen display information, the generated information elements and the like under the control of the CPU 21, and temporarily stores the generated information in the RAM 22 or the data storage unit 24. The generated information creation architecture 33 edits, for example, the method “createElement(“region”)” of a DOCUMENT object and the like to relates to the method with the other objects. As a result, the generated information creation architecture 33 creates the program generation information.

By the operation up to this stage, the generated information for editing the DOM tree, which is shown in FIG. 4 and corresponds to the specific screen display information for displaying the information of “asahi.com/national/index.html” and “asahi.com” alternately every 30 seconds in the screen area \mathring{2} of FIG. 9 has been created. More specifically, the DOM tree to be edited defines to display the information alternately every 30 seconds by the “seq” element, and defines that the objects to be displayed alternately every 30 seconds are the information of “asahi.com/national/index.html” and “asahi.com” by an attribute 205 being the attribute of “text” elements.

By the operation up to this stage, the program generation information for all of the screen areas of the screen layout example 12 shown in FIG. 7 has been generated. After the generation of the last generated information, the generated information creation architecture 33 judges whether there is any screen areas in which no generated information is generated, in Step ST109, under the control of the CPU 21. If there is screen area in which no generation information is generated, the process returns to Step ST102, and necessary generated information is generated.

In addition, if the generated information creation architecture 33 judges that there are no screen areas in which no generated information is generated, the generated information creation architecture 33 makes the information display architecture 30 display an input screen concerning whether there are any amendment in all of the specific screen display information and screen settings up to this stage.

In this input screen, if the user inputted the information indicating the existence of some amendments in the screen settings with the remote control unit 40 and the like, the response information input architecture 31 instructs the information display architecture 30 to display an input screen of the information indicating whether the process returns to the first setting screen, under the control of the CPU 21.

If the user inputted to return to the first setting screen in the input screen of the information indicating whether the process returns to the first setting screen, then the process returns to the step of Step ST101. In addition, if the user did not input the information to return to the first setting screen, then the process judges that the user wants to perform the amendments of individual screen areas, and returns to the step after Step ST102 to perform a selection of a source and the like again, in Step ST111.

In addition, if the user did not input the information of the existence of the amendments of screen settings, then the response information input architecture 31 judges that the user does not want to amend the screen settings, and reads in the program generation information for all of the screen areas from the RAM 22, the data storage unit 24 and the like to output the read generated information to the display program generation architecture 34.

The display program generation architecture 34 relates all of the inputted generated information to each other while editing the DOM tree. As a result, the display program generating architecture 34 generates the DOM tree as shown in FIG. 4 and FIG. 5, then finally generates the SMIL data as shown in FIG. 3, in Step ST112.

The generation of the SMIL data as the display program is completed by the processes described above. The generated SMIL data can be stored in the data storage unit 24 as the display program data 28, as the need arises. As a result, it is possible to use the SMIL data as a favorite display program any number of times. In addition, as the need arises, upon preparing several kinds of SMIL data beforehand, the SMIL data can be synchronously reproduced easily and fast reading in the SMIL data.

Next, the operation of the television set 1 for displaying a plurality of image data and the like actually on the display unit 17 of the television set 1 the basis of the generated SMIL data, for example, at the same time will be described.

First, the script reading architecture 35 read out the display program generated by the operation at Step ST112 from the display program data 28 of the data storage unit 24, and the reading in of the program is begun under the control of the CPU 21, in Step ST113.

In addition, it is judged whether the description read in the script determination architecture 36 is XML data or not, and whether the description is SMIL data or not (Step ST114). If the description is judged to be neither an XML text nor a SMIL text, an error process is performed, in Step ST115. That is, the process returns to the step before Step ST113.

In addition, if the description is judged to be SMIL data, the CPU 21 instructs the script determination architecture 36 to start the parsing of the SMIL data, then the script determination architecture 36 begins the cutting and the division of the SMIL data, in Step ST116.

Next, the script determination architecture 36 divides the cut and divided parts into, for example, the parts for defining a plurality of display areas and for performing the layout of each of the display areas, and the parts for defining the external information sources the information from which is displayed in the defined display areas and for attaching other information thereto. Then, the script determination architecture 36 judges the contents of respective parts.

For example, as the method for defining a plurality of display areas and for performing the layouts of the display areas, the script determination architecture 36 outputs the layout information of the root-layout and the region elements of <layout type=“text/smil-basic-layout”>of the element 102 to </layout>of the element 107 in the SMIL data shown in FIG. 3 to the layout architecture 37 for performing the layout of the screen of the television set 1, in Step ST117.

Hereupon, since top=0, left=0 in the region element of the element 104, it is declared that the upper left of the screen area of “r1” is located at the position shifted downward from the upper end by 0 and shifted to the right side by 0. In addition, if time elements are also incorporated in this case, a layout associated with time can also be performed.

Next, for the judgment of the existence of the schema of URI's defining the external information sources from which information is displayed in the display areas defined by region elements, for example, the script determination architecture 36 extracts attribute names “src” from the body elements of the SMIL data, in Step ST118, and judges whether “videoinput”, one of the schema of the URI's exists.

Hereupon, if the script determination architecture 36 judges that “videoinput” exists, the script determination architecture 36 transmits the parameter being the display information following “videoinput” to the interface selection architecture 38. The interface selection architecture 38 selects an interface on the basis of the transmitted parameter.

In addition, if the script determination architecture 36 judges that “videoinput” does not exist, a screen is reproduced as the image information designated by a URL of the Web, for example, in case of the description as the element 110 in FIG. 3, in Step ST119.

Next, if the script determination architecture 36 judged that “videoinput” existed and the interface selection architecture 38 selected an interface, the script determination architecture 36 further judges the content of the part to which other information is attached as well as the part defining the external information source the information from which is displayed in a display program. Then, the information is transferred to the interface, and image information and the like is reproduced on the display unit 17 in accordance with the definition, in Step ST119.

In addition, after the display of image information and the like, the script determination architecture 36 judges whether the information such as the numeral specified by the operation of the remote control unit 40 and the like has been inputted into the response information input architecture 31 under the control of the CPU 21. If the script determination architecture 36 judged that the information had been inputted, the process returned to the step after Step ST112. If the script determination architecture 36 judged that the information had not been inputted, then the information such as an image, still image and the like specified by the screen layout is continuously displayed. As a result, if a plurality of display programs is stored in the data storage unit 24, screens, the layouts of which are performed by different display programs are displayed in sequence, and a desired layout screen can be selected in a simple manner.

Next, if the script determination architecture 36 judged that a display program included “?”, the information of “?” and the following are outputted to the information control architecture 39 and the like. Then, the information control architecture 39 and the like specifically transfers the information of “?” and the following to each architecture such as the interface unit 2 under the control of the CPU 21. Thus, information such as an image, text and the like is inputted to each apparatus such as the interface unit 2 and the like, and then the image, a still image and the like is displayed on the display unit 17 in accordance with the screen layout under the control of the CPU 21, in Step ST119.

For example, if a description like “fujitv.co.jp” exists after “?” in the video element 108 as shown in FIG. 3, the control information for the acquisition of the information of a channel of Fuji Television Network, Inc. is transferred to each apparatus.

As a result, the transfer of the information of the layout, content of a desired display screen and the like are performed by each apparatus such as the interface unit 2, and it becomes possible to perform a fee layout screen display independent from the type of the external information source.

The above description illustrate the operation of a television set 1 according to a preferred embodiment of the present invention, focused on the generation of a display program.

As described above, according to the present preferred embodiment of the present invention, selected display information such as the location and the size of a display screen area and the like for the generation of a program to display an image on the display unit 17 is displayed on the display unit 17, and generated information for generating the program corresponding to the selected display information such as a plurality of kinds of elements of editing information of a DOM tree are stored. Then, a stored element is selected according to the selected display information displayed on the display unit, and generated information is generated. As a result, a program for displaying the image is generated on the basis of the generated information. Selection and combination may be carried out by simple operations without the user having to be aware of detailed constitutive elements, and a more customized free layout screen may be created.

In addition, since selected display information may include a plurality of selection choices, for example, a number corresponding to a selected choice can be easily specified with a remote control unit and the like, and the source of desired display information and the like can be easily inputted into electronic apparatus. In addition, it is possible to specify the information desired for view to categorize the information. Thus, a user may create a free layout screen with the remote control unit among a plurality of selection choices of hierarchical categories from roughly specifyed one to fully detailed information.

More specifically, when a user pushes the numeric key 41 in order with the remote control unit 40 in accordance with the guidance displayed in an easily understandable method using a picture and the like displayed on the display unit 17 as shown in FIG. 7 and FIG. 9 to FIG.13, the response information input architecture 31 and the element reading architecture 32 read in necessary generated information elements under the control of the CPU 21. Then, the generated information creation architecture 33 creates generated information for editing a DOM tree. As a result, it becomes unnecessary for a user to generate, for example, SMIL data directly by the difficult editing of the DOM tree, and it becomes possible for the user to perform the layout of a free screen by simple operations.

In addition, since the control unit 6 makes the display unit 17 display the selected display information different from the selected display information displayed on the display unit 17 after being selected, it is possible to display selected display information on the display unit 17 one after another. For example, since a user may display screen layout examples one after another by simple operations with a remote control unit and the like, improvement of usability may be expected.

In addition, selected display information for the generation of a program for displaying an image on a display unit, for example, the location and the size of a display screen area is displayed on the display unit, and the generated information for generating a program corresponding to the selected display information such as the editing information itself of the DOM tree is stored. Then, the generated information stored corresponding to the selected display information displayed on the display unit, and a program for generating an image is generated on the basis of the generated information. As a result, a user him or herself may create free layout screen with simpler operations.

In addition, parts for defining a plurality of display areas in a generated display program and performing the layout of each program, and parts for defining the external information source the information from which is displayed in the defined display area and for attaching other information are described. As a result, it is possible to define the display of the information from a specific external information source, and then a layout of the information from the external information source may be freely performed by means of the rules of a URI.

In addition, instead of editing the so-called layout description which is implemented in conventional PCs, the present preferred embodiment of the invention is on the assumption of editing in the television set 1, a PDA and the like. Then, the examples of preferred embodiments use the remote control unit 40, Jog Dial and the like, which are widely and popularly provided with the television set 1, the PDA and the like as a user interface. A desired layout display may be realized with relatively sensitive operations.

In addition, not only moving images, still images or text, but also the Web itself is considered as a medium having adjustable layout. The input of a URL in this case sometimes forces a user into complex operations. In the examples of preferred embodiments of the present invention, a plurality of pieces of selected display information is stored, and selection choices may be displayed on the display unit 17 by the information display architecture 30. As a result, without inputting any URL, selection may be performed with the remote control unit 40 and the like, and usability may be improved.

In addition, information desired for watch or view is specified and categorized to, for example, news network, a weather, information. Then, the information is hierarchically displayed on a screen. As a result, desired information may be specified in a simple manner by operations with the remote control unit 40, Jog Dial and the like.

After this, it is considerable to use more customized SMIL data when a user layouts a plurality of media which the user wants to browse at the same time on the assumption of a device such as a television, PDA, a portable telephone and the like in place of the reproduction of a layout using synchronous information such as the layout of the SMIL and the like supplied from a server.

In this case, selected display information such as the location and the size of a display screen area for the generation of a program for displaying an image on a display unit is displayed on the display unit, and a plurality of kinds of elements of generated information for generating a program corresponding to the selected display information such as the editing information of a DOM tree is stored. Then, the stored elements are selected corresponding to the selected display information displayed on the display unit, and generated information is generated. Furthermore, a program for generating an image on the basis of the generated information is generated. As a result, the program may be customized relatively easily.

More specifically, it is possible to reduce or avoid character inputting, which is difficult in televisions, PDAs and the like, and to operate the selection of choices on a screen basically only with a device such as a remote controlling device, a Jog Dial and the like which may be operated relatively easily.

In addition, also in case of performing the display of the Web, the display of a desired content is performed by selecting a genre categorized to some degree, in addition to the inputting of a URL, which is relatively difficult. As a result, it becomes possible to perform customization having good affinity to television, PDA and other appliance or apparatus.

The present invention is not limited to the above-mentioned examples of preferred embodiments, so that the examples of preferred embodiments of the present invention and equivalents thereof may be appropriately modified, combined or sub-combined to be implemented within the scope and the sprit of the invention.

For example, in the preferred embodiment described above, the case where a display program is generated and the generated display program as it is or the display program stored in the data storage unit 24 is read in by the script reading architecture 35 to perform a screen layout has been described. However, it is also possible to download a display program from a supply side server through the Internet to perform the screen layout.

As a result, more display programs including layout information may be utilized, and customization features may be further improved.

In addition, in the above-mentioned preferred embodiments, description has been made for the case of a television set 1. However, the present invention is not limited to the television set 1. Accordingly, the present invention may be implemented to a PDA, a portable telephone and the like by the use of a Jog Dial or another form of display navigation or operation tool. As a result, for example, in a portable telephone with a camera function, when an image photographed with the camera is transmitted together with other text information and the like by electronic mail, for example, the layout of the screen may be freely designed with simple operations. The functionality of information communication may be widely expanded.

In addition, in the above-mentioned preferred embodiments, a plurality of screen layout examples is displayed in the operation of the television set 1 first. However, selected display information may be created so as to carry out further customization of the existing screen layout. For example, the size and the like of each screen area may be finely selected. As a result, a freer screen layout may be performed in a simple manner.

What is claimed is:

1. An electronic apparatus comprising:
a display section for displaying image;
a housing means for housing a plurality of types of constitutive elements utilized in generation of generated information for generating a program for display of image on said display section, and for housing selected display information for selection of a constitutive element from said plurality of types of constitutive elements on said display section;
a selection means for selecting a constitutive element from said plurality of types of constitutive elements, according to said selected display information displayed on said display section; and
a generation means for generating said generated information based on a result of selection by said selection means and generating said program based on said generated information.

2. The apparatus according to claim 1, wherein said selection means selects and displays on said display section a plurality of selected display information from said plurality of selected display information housed in said housing means, if there is a plurality of selected display information housed in said housing means.

3. The apparatus according to claim 2, wherein said selection means makes display on said display section, selected display information other than said selected and displayed selected display information.

4. The apparatus according to claim 1, wherein said housing means houses a program generated by said generation means.

5. An electronic apparatus comprising:
a display section for displaying image;
a housing means for housing a plurality of generation information for generating a program for display of image on said display section, and for housing selected display information for selection of a piece of generation information from said plurality of generation information on said display section;
a selection means for selection of a piece of generation information from said plurality of generation information, according to said selected display information displayed on said display section; and
a generation means for generating said program based on a result of said selection.

6. A program generation method comprising:
a housing step of housing a plurality of types of constitutive elements utilized in generation of generated information for generating a program for display of image on a display section, and of housing selected display information for selection of a constitutive element from said plurality of types of constitutive elements on said display section;
a selection step of selecting a constitutive element from said plurality of types of constitutive elements, according to said selected display information displayed on said display section; and
a generation step of generating said generated information based on a result of selection by said selection step and generating said program based on said generated information.

7. The method according to claim 6, wherein said selection step selects and displays on said display section a plurality of selected display information from said plurality of selected display information housed in said housing step, if there is a plurality of selected display information housed through said housing step.

8. The apparatus according to claim 7, wherein said selection step makes display on said display section, selected display information other than said selected and displayed selected display information.

9. A program generation method comprising:
a housing step of housing a plurality of generation information for generating a program for display of image on a display section, and of housing selected display information for selection of a piece of generation information from said plurality of generation information on said display section;
a selection step of selection of a piece of generation information from said plurality of generation information, according to said selected display information displayed on said display section; and
a generation step of generating said program based on a result of said selection.
